(19) United States
(12) Patent Application Publication
(10) Pub. No.: US 2023/0174785 A1
(43) Pub. Date: Jun. 8, 2023

(54) STOVER BASED COMPOSITIONS AND USES THEREOF

(71) Applicant: RBW, LLC, Sioux Falls, SD (US)

(72) Inventors: Kelly Ross Randall, Dell Rapids, SD (US); Adam Raymond Wolff, Dell Rapids, SD (US); Matthew Thomas Burkhart, Dunlap, IA (US)

(21) Appl. No.: 18/073,656

(22) Filed: Dec. 2, 2022

Related U.S. Application Data
(60) Provisional application No. 63/264,795, filed on Dec. 2, 2021.

(51) Int. Cl. C08L 97/02; C08K 7/14

(52) U.S. Cl. CPC C08L 97/02; C08K 7/14; C08L 2205/035

(57) ABSTRACT

The invention describes compositions of a cellulosic and fiberglass that can utilize, for example, recycled materials thus benefitting the environment and reducing waste materials.

### CROSS REFERENCE TO RELATED APPLICATIONS

This application claim priority to provisional application No. 63/264795, filed Dec. 2, 2021 and entitled STOVER BASED COMPOSITIONS AND USES THEREOF, the entire contents of which are incorporated herein by reference.

### FIELD OF THE INVENTION

The invention relates generally to compositions of cellulosic materials, such as stover materials, fiberglass, and optional additives such as pigments, binders, fillers, etc.

### BACKGROUND OF THE INVENTION

In agriculture, there is a large amount of waste generated from crops such as corn, alfalfa, soybean or wheat. The remnants include the stalk, husk, cob and leaves. Some of this waste can be fed to farm animals, however, there is an abundance of material that the agriculture business cannot process and can become an environmental issue.

Worn out, broken, dilapidated fiberglass products, such as windmill blades and containers are not easily disposed of Generally, they are buried as waste into a landfill, sometimes along with garbage. Again, this is an environmental issue in that the fiberglass does not readily decompose, thus filling up landfill space and not degrading for centuries, if at all.

Therefore, a need exists to address ways to recycle and use such waste materials in a useful and beneficial manner.

### BRIEF SUMMARY OF THE INVENTION

The present invention surprisingly provides a composition comprising: a cellulosic material and fiberglass, optionally with additives such as pigments, fillers, binders and/or one or more of a polyethylene, a polypropylene, a polybutylene or a polyurethane.

The cellulosic can be a biomass material, such as wood, sawdust, bagasse, fruit pits, fruit cores, vegetable pits, vegetable cores, stover, or a grass. Alternatively, the cellulosic material can be cardboard, card stock, cartons, corrugated fiberboard, paperboard, paper or newspaper. Many of the biomass items can be recycled so that they do not find their way into a landfill.

Generally, the fiberglass component is derived from recycled windmill blades, containers, or other suitable sources of items that contain fiberglass that would otherwise not be recycled.

By use of the cellulosics (which can be waste products or recycled materials) and the reclaimed fiberglass, the present embodiments help to remove such potential waste material from landfills and to help the environment. Additionally, the compositions described herein, if ever broken, become dilapidated, not functioning as required for their application, etc., can be further recycled due to the nature of the composition. This is yet another advantage of the embodiments disclosed herein to avoid having to have the materials be buried in a landfill.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DETAILED DESCRIPTION

In the specification and in the claims, the terms “including” and “comprising” are open-ended terms and should be interpreted to mean “including, but not limited to . . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

In one embodiment, a composition comprising a cellulosic material and fiberglass is provided.

The cellulosic material can be biomass. The term “biomass” is recognized in the art and is intended to include cellulosic or lignocellulosic materials. Sources of biomass include, but are not limited to, wood, sawdust, bagasse, fruit pits, fruit cores, vegetable pits, vegetable cores, stovers (such as corn, sorghum, soybean), seaweed, straw, wheat, or grasses or mixtures thereof.

The term “stover” is recognized in the art and is intended to include leaves and stalks of field crops, including cobs, husks, seed pods, etc. or mixtures thereof. Therefore corn stalks are an example of a stalk.

In another embodiment, the cellulosic material can be cardboard, card stock, cartons, corrugated fiberboard, paperboard, paper or newspaper or mixtures thereof.

In another embodiment, materials that are fibrous are included to provide fibers to the composition. These fibers can impart strength and integrity to the composition and ultimate product. Fibrous materials, some of which are disclosed herein, include corn stalks, corn husk, bamboo and fibrous bamboo biomass, etc. The examples are not to be limiting. Fibers can include string, carbon fibers, nylon fibers, polyester fibers, etc. including polypropylene, polyethylene and various copolymers of materials that can be formed into fibrous substrates.

In the embodiments described herein, fiberglass is incorporated into the compositions. The fiberglass can be obtained from any source. However, it is beneficial to recycle used, dilapidated, broken, malfunctioning, etc. windmill blades, fiberglass containers, or other fiberglass products. Any item that is constructed with fiberglass can be used in the composition.

Generally, the fiberglass item is ground into particles or powders prior to use with the compositions so that the fiberglass and cellulosic can be mixed together. In one aspect, the mixture is homogeneous with the materials dispersed therein. In another aspect, the mixture does not need to be homogeneous.

In one aspect, the fiberglass that is particularized or powdered is heated to a molten state and combined with the cellulosic. The heated fiberglass does not need to become liquid; however, a liquid state of the fiberglass is acceptable. The components are mixed until a suitable composition is prepared.

In yet another aspect, the molten or liquid fiberglass can be coated onto preformed cellulosic components such that the cellulosic component serves as the support for the fiberglass coating.

In still another embodiment, a mixture of the particularized or powdered fiberglass and the cellulosic can be combined and heated to a molten or liquid mixture.

The mixture of the cellulosic and fiberglass can be extruded into various forms, such as rods, pellets, cable, boards, sheets, etc. and then used to construct items, such as pallets. The cellulosic/fiberglass composition can be a molten/fluid mixture.

One advantage of the cellulosic/fiberglass compositions described herein is the use of materials that may be disposed of in a landfill thus potentially harming the environment. The recycling of these materials is beneficial for the environment, helps reduce waste and provides an economic advantage of not having to dispose of the items and the generation of jobs to prepare the compositions described herein.

Recycled plastics can also be used in the compositions described herein. Suitable recycled plastics include, but are not limited to, polyethylene, polybutylene, polypropylene, polyesters, polyamides, polystyrenics, and polyurethanes, and mixtures thereof, etc. that are recyclable. Such materials can be formed into fibers if desired.

In an aspect, the cellulosic/fiberglass compositions described herein include from about 1% to about 90% by weight of cellulosic material of the total weight of the composition.

In another aspect, the cellulosic/fiberglass compositions described herein include from about 20% to about 50% by weight of cellulosic material of the total weight of the composition.

In still another aspect, the cellulosic/fiberglass compositions described herein can further include a polyethylene, a polypropylene, a polybutylene or a polyurethane or mixtures thereof.

The cellulosic/fiberglass compositions described herein can further include one or more additives (including polyethylenes, polypropylenes, poybutylenes or polyurethanes) including, but not limited to, binders, pigments, fillers, UV inhibitors, wetting agents, flow agents, flattening agents, rheology control agents, anti-settling, traditional adhesives used with OSB boards, anti-sag agents and/or slip agents.

Suitable adhesives that can be used to prepare the compositions disclosed herein include epoxies, cyanoacrylates, urethanes and acrylic based adhesives.

Suitable binders include, but are not limited to, epoxy resins, polyester resins, phenolic resins, gum Arabic, gum tragacanth, a methylcellulose or mixtures thereof.

Suitable pigments include, but are not limited to, those generally recognized by persons of ordinary skill in the art. For example, the pigment may be a typical organic or inorganic pigment, especially those set forth in the Color Index, 3rd ed., 2nd Rev., 1982, published by the Society of Dyers and Colourists in association with the American Association of Textile Chemists and Colorists.

Suitable fillers include, but are not limited to, silicas, clays, mica, carbon fibers, carbon blacks, kaolins, diatomaceous earths, calcium carbonate, magnesium carbonate, basic magnesium carbonate, aluminosilicate, aluminum trihydroxide, aluminum oxides (alumina), titanium oxides, zinc oxide, barium sulfate, calcium sulfate, zinc sulfide, satin white, alumina hydrate such as boehmite, zirconium oxide or mixtures thereof.

Suitable examples of UV absorbers and UV light stabilizers include, but are not limited to, substituted benzophenone, substituted benzotriazoles, hindered amines, and hindered benzoates, diethyl-3-acetyl hydroxy-benzyl-phosphonate, 4-dodecyloxy-2-hydroxy benzophenone, resorcinol monobenzoate or mixtures thereof.

Examples of flattening agents include, but are not limited to, synthetic silica, available from the Davison Chemical Division of W. R. Grace & Company as SYLOID™; polypropylene, available from Hercules Inc., as HERCOFLAT™; and synthetic silicate, available from J. M. Huber Corporation, as ZEOLEX™.

One or more additive(s) can be present in the cellulosic/fiberglass composition from about 0.1% to 25%, 0.5% to 20%, from about 1% to 20%, from about 5% to about 20%, from about 2% to 10%, from about 10% to about 15% or from about 1% to about 10% by weight of the total composition.

The following paragraphs enumerated consecutively from 1 through 25 provide for various aspects of the present invention. In one embodiment, in a first paragraph (1), the present invention provides a composition comprising: a cellulosic material and fiberglass.

2. The composition according to paragraph 1, wherein the cellulosic material is a biomass material.

3. The composition according to paragraph 2, wherein the biomass material is wood, sawdust, bagasse, fruit pits, fruit cores, vegetable pits, vegetable cores, stover, or a grass.

4. The composition according to either paragraph 1 or 2, wherein the biomass is stover.

5. The composition according to either paragraph 1 or 2, wherein the cellulosic material is cardboard, card stock, cartons, corrugated fiberboard, paperboard, paper, newspaper or mixtures thereof.

6. The composition according to any of paragraphs 1 through 5, wherein the fiberglass is derived from windmill blades or containers that have been recycled and granulated or powdered.

7. The composition according to any of paragraphs 1 through 6, wherein from about 1% to about 90% by weight of the cellulosic material is present in the composition.

8. The composition according to paragraph 7, wherein from about 20% to about 50% by weight of the cellulosic material is present.

9. The composition according to any of paragraphs 1 through 8, further comprising a polyethylene, a polypropylene, a polybutylene, a polyurethane or mixtures thereof.

10. The composition according to paragraph 9, wherein the polyethylene, polypropylene, polybutylene or polyurethane is present from about 1% to 25% by weight of the total composition.

11. The composition according to paragraph 10, wherein the polyethylene, polypropylene, polybutylene or polyurethane is present from about 1% to 10% by weight of the total composition.

12. The composition according to any of paragraphs 1 through 11, further comprising a binder.

13. The composition according to paragraph 12, wherein the binder is an epoxy resin, a polyester resin, a phenolic resin, gum Arabic, gum tragacanth, a methyl cellulose or mixtures thereof.

14. The composition according to paragraph 13, wherein the binder is present from about 1% to about 25% by weight of the total composition.

15. The composition according to paragraph 14, wherein the binder is present from about 1% to 10% by weight of the total composition.

16. The composition according to any of paragraphs 1 through 15, further comprising a pigment.

17. The composition according to paragraph 16, wherein the pigment is present from about 1% to about 25% by weight of the total composition.

18. The composition according to paragraph 17, wherein the pigment is present from about 1% to 10% by weight of the total composition.

19. The composition according to any of paragraphs 1 through 18, further comprising a filler.

20 The composition according to paragraph 19, wherein the filler is a silica, a clay, mica, alumina, carbon fibers, carbon black, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, alumina hydrate such as boehmite, zirconium oxide or mixtures thereof.

21. The composition according to paragraph 19, wherein the filler is present from about 1% to about 25% by weight of the total composition.

22. The composition according to paragraph 21, wherein the filler is present from about 1% to 10% by weight of the total composition.

23. A process to prepare a composition according to any of paragraphs 1 through 22 comprising the steps:

grinding fiberglass windmill blades or fiberglass containers into a particulate or a powder fiberglass component;

heating the fiberglass component to a provide a molten fiberglass;

combining the molten fiberglass with the cellulosic to provide a cellulosic and fiberglass composition; and

optionally forming the cellulosic and fiberglass composition into pellets, rods, boards or cable.

24. The process according to paragraph 23, wherein the formed cellulosic and fiberglass composition is extruded.

25. The process according to either paragraph 23 or 24, wherein the formed cellulose and fiberglass composition is formed into a pallet, furniture, or fencing.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A composition comprising: a cellulosic material and fiberglass.

2. The composition according to claim 1, wherein the cellulosic material is a biomass material.

3. The composition according to claim 2, wherein the biomass material is wood, sawdust, bagasse, fruit pits, fruit cores, vegetable pits, vegetable cores, stover, or a grass.

4. The composition according to claim 1, wherein the biomass is stover.

5. The composition according to claim 1, wherein the cellulosic material is cardboard, card stock, cartons, corrugated fiberboard, paperboard, paper, newspaper or mixtures thereof.

6. The composition according to claim 1, wherein the fiberglass is derived from windmill blades or containers that have been recycled and granulated or powdered.

7. The composition according to claim 1, wherein from about 1% to about 90% by weight of the cellulosic material is present in the composition.

8. The composition according to claim 7, wherein from about 20% to about 50% by weight of the cellulosic material is present.

9. The composition according to claim 1, further comprising a polyethylene, a polypropylene, a polybutylene, a polyurethane or mixtures thereof.

10. The composition according to claim 9, wherein the polyethylene, polypropylene, polybutylene or polyurethane is present from about 1% to 25% by weight of the total composition.

11. The composition according to claim 10, wherein the polyethylene, polypropylene, polybutylene or polyurethane is present from about 1% to 10% by weight of the total composition.

12. The composition according to claim 1, further comprising a binder.

13. The composition according to claim 12, wherein the binder is an epoxy resin, a polyester resin, a phenolic resin, gum Arabic, gum tragacanth, a methyl cellulose or mixtures thereof.

14. The composition according to claim 13, wherein the binder is present from about 1% to about 25% by weight of the total composition.

15. The composition according to claim 14, wherein the binder is present from about 1% to 10% by weight of the total composition.

16. The composition according to claim 1, further comprising a pigment.

17. The composition according to claim 16, wherein the pigment is present from about 1% to about 25% by weight of the total composition.

18. The composition according to claim 17, wherein the pigment is present from about 1% to 10% by weight of the total composition.

19. The composition according to claim 1, further comprising a filler.

20 The composition according to claim 19, wherein the filler is a silica, a clay, mica, alumina, carbon fibers, carbon black, kaolin, diatomaceous earth, calcium carbonate, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, alumina hydrate such as boehmite, zirconium oxide or mixtures thereof.
